(19) United States
(12) Patent Application Publication
(10) Pub. No.: US 2015/0223532 A1
(43) Pub. Date: Aug. 13, 2015

(54) Electroluminescent Costume Mask

(71) Applicant: Juan William Rodriguez, Vancouver, WA (US)

(72) Inventor: Juan William Rodriguez, Vancouver, WA (US)

(21) Appl. No.: 14/621,915

(22) Filed: Feb. 13, 2015

Related U.S. Application Data
(60) Provisional application No. 61/939,532, filed on Feb. 13, 2014.

(51) Int. Cl. A41D 27/08; H05B 37/02; F21V 21/084; H05B 33/08

(52) U.S. Cl. CPC A41D 27/085; H05B 33/08; H05B 37/02; F21V 21/084

(57) ABSTRACT

An illuminated costume mask is provided. The costume mask comprises a face covering that is designed to cover a portion of the user's face. The mask comprises an upper and lower surface, upon one of which is disposed an electroluminescent device such that the mask is illuminated when the electroluminescent device is energized. The electroluminescent device comprises one of an elongated electroluminescent wire or an electroluminescent panel, whereby the wire embodiment is formed in a desired pattern along the upper or lower surfaces of the mask, and the panel embodiment is disposed along one of the upper or lower surfaces of the mask. Powering the device is a battery power source electrically coupled to the electroluminescent device. The power source is supported within a body-worn housing and is operably connected to the electroluminescent device, whereby the user can control the electroluminescent device using an activation switch or the electrical coupling.

### CROSS REFERENCE TO RELATED APPLICATION

This application claims the benefit of U.S. Provisional Application No. 61/939,532 filed on Feb. 13, 2014. The above identified patent application is herein incorporated by reference in its entirety to provide continuity of disclosure.

### BACKGROUND OF THE INVENTION

### Field of the Invention

The present invention relates to mask devices and to electroluminescent assemblies. More specifically, the present invention relates to an electroluminescent mask device that employs one of a wire electroluminescent device or panel electroluminescent device to illuminate a specifically design mask for improved ornamental purposes.

Electroluminescent devices are those devices that illuminate when an electrical current is applied thereto. Applications of electroluminescent devices include electroluminescent wire and electroluminescent panels. Electroluminescent wires comprise elongated wire assemblies that emit light along its outer surface when an electrical current is passed therethrough. Electroluminescent panels are surfaces which emit light from at least one side thereof when an electrical current is passed therethrough. For the purposes of disclosure, a typical construction of both is provided below. The present invention contemplates a mask device that incorporates one of an electroluminescent wire or electroluminescent panel into its construction to add illuminating features to the mask for ornamental purposes.

Electroluminescent wires are elongated assemblies having a cross section comprising a solid copper core that has an exterior surface coating of phosphorescent or fluorescent material. Disposed over and around the surface coating is a small diameter copper wire that is coiled therearound and insulated from the copper core. Over this assembly are generally one or more sleeves that encase the assembly along the length of the wire. An electrical current is introduced between the copper core and the small diameter wire, which causes the coating to emit light. The type of coating will dictate the color of the emitted light, which is emitted along the length of the wire where the coating is applied. Variations of this basic construction are contemplated for the purposes of providing an elongated, malleable wire that emits a desired color when electrically energized.

In contrast to electroluminescent wires, electroluminescent panels emit illumination from a larger surface and operate using a capacitor and a dielectric between surface plates to give off light when the capacitor is charged. Electroluminescent panels, or light-emitting capacitors, provide a surface area that provides coextensive light emission therefrom. Electroluminescent wires are useful because of their ability to be bent and formed into a desired pattern, while electroluminescent wires are useful for projecting light from a larger surface area, and therefore are useful as backlighting. The present invention contemplates use of both wires and panels for the purposes of illuminating a decorative costume mask.

### SUMMARY OF THE INVENTION

The following summary is intended solely for the benefit of the reader and is not intended to be limiting in any way. The present invention provides a new costume mask that is configured to be worn on the head of the user and preferably over the face thereof, wherein the mask utilizes an electroluminescent device to emit light from the mask. The mask design can be provided in different ornamental configurations, while the electroluminescent device is one of an electroluminescent wire or panel disposed above or below the mask surface and controlled by a power source worn on the body of the user.

It is therefore an object of the present invention to provide a new and improved costume mask device that has all of the advantages of the prior art and none of the disadvantages.

It is another object of the present invention to provide a mask that provides a head or face covering, whereby the mask is electrically connected via an elongated wire to a power source, and the power source delivers electrical power to an electroluminescent device disposed on the surface of the mask.

Another object of the present invention is to provide a mask that is illuminated by an electrical current, providing a highly visible mask in low light and one that can remain illuminated while a power source is delivering electrical power.

Yet another object of the present invention is to provide a mask that can operate over extended periods before replacement and beyond the capabilities of most non-powered, chemical fluorescent light sources.

Another object of the present invention is to provide a mask that is includes one of a electroluminescent wire or electroluminescent surface, whereby the electroluminescent device is disposed above or below the mask for different uses of illumination (i.e. backlighting, exterior light projection, a defined path of light, a larger surface area of illumination, etc.).

Another object of the present invention is to provide a mask that is includes an electric circuit that controls the electrical power from the battery power source and delivers the necessary current to the electroluminescent device for optimum illumination power without sacrificing longevity or safety.

Another object of the present invention is to provide a mask that can be designed in any ornamental shape or pattern to suit the preferences of the user or the occasion, whereby the mask may include a variety of surface shapes, apertures therealong, and may cover the user's face or the entire head of the user when donned.

A final object of the present invention is to provide a mask that is includes may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a view of an embodiment of the costume mask, in which an electroluminescent wire is disposed thereon.

FIG. 2 shows sides view of an embodiment of the costume mask being worn over the face of a user and coupled to the battery power source.

FIG. 3 shows another side view of the costume mask worn over the face of a user and the power source being body-worn.

FIG. 4 shows views of the housing supporting the battery power source and the quick connect coupling between the housing and the costume mask.

FIG. 5 shows a rear view of the mask being work and an elastic band supporting the mask around the head of the wearer.

FIG. 6 shows another embodiment of the costume mask surface, serving as a base for the electroluminescent device to be supported.

FIG. 7 shows a view of the electroluminescent wire disposed along the exterior surface of the costume mask.

FIG. 8 shows the electroluminescent wire of the custom mask illuminated when powered by the electric current of the battery power source.

FIG. 9A shows another embodiment of the custom mask design.

FIG. 9B shows another embodiment of the custom mask design.

FIG. 9C shows another embodiment of the custom mask design.

FIG. 9D shows another embodiment of the custom mask design.

FIG. 10 shows a view of the costume mask supporting an electroluminescent panel thereon.

FIG. 11A shows an embodiment of the costume mask in which the electroluminescent panel is coextensive with the costume mask surface.

FIG. 11B shows another embodiment of the costume mask in which the electroluminescent panel is coextensive with the costume mask surface and provides backlighting therefor.

### DETAILED DESCRIPTION OF THE INVENTION

Reference is made herein to the attached drawings. Like reference numerals are used throughout the drawings to depict like or similar elements of the illuminated costume mask of the present invention. For the purposes of presenting a brief and clear description of the present invention, the preferred embodiment will be discussed as used for providing an illuminated costume mask worn on the face or head of the wearer and deriving electrical power from a body-worn power supply. The figures are intended for representative purposes only and should not be considered to be limiting in any respect.

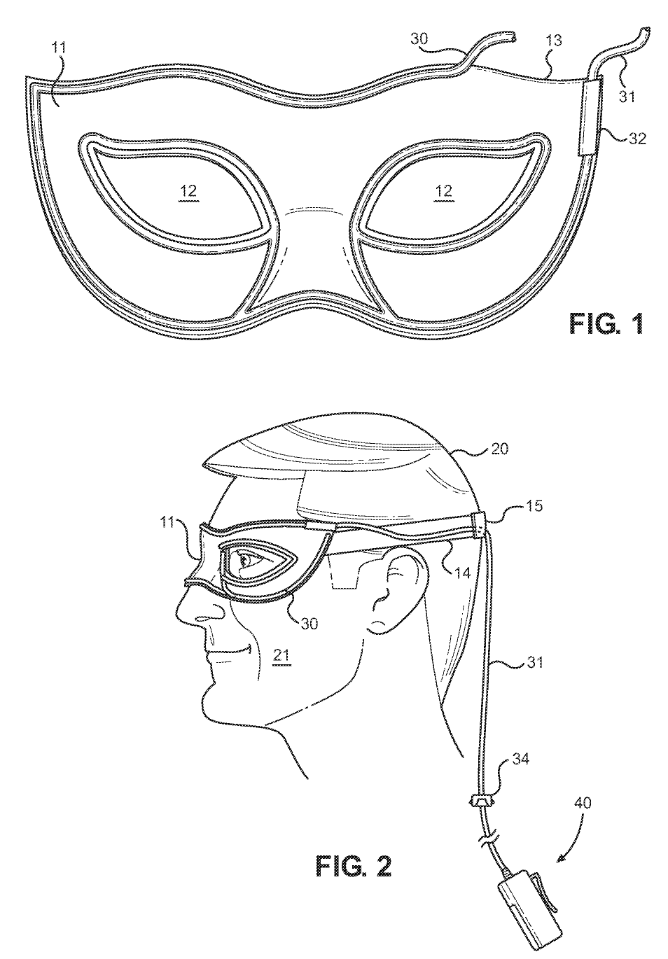

Referring now to FIG. 1, there is shown a view of an embodiment of the costume mask 11 of the present invention. The costume mask 11 comprises a mask device that is configured to cover at least a portion of the user's face or a portion of the user's head for ornamental purposes. The costume mask 11 is one that is used for events or for occasions in which dressing up or otherwise placing ornamental objects on one's head or face is desired. The mask 11 comprises an exterior surface, an interior surface, and an outer edge 13. The interior surface is contoured to conform to the user's face or head, depending on the design of the mask 11, and may including one or more apertures 12 extending therethrough. The apertures 12 may include purely ornamental features, or furthermore provide functional apertures 12 in the form of eye holes or ear holes. The exact shape, contour, and design of the costume mask 11 may take on several forms. It is not desired limit the shape, number or configuration of the apertures, the exterior edge or the ornamental shape of the mask to one specific configuration. Rather, the present invention comprises a lighted embodiment thereof that combines the decorative features of a costume mask with the aesthetics of a light source thereon.

Disposed along the interior or exterior surface of the mask 11 is an electroluminescent device in the form of an electroluminescent wire 30 or an electroluminescent panel. The electroluminescent wire 30 is an elongated wire member having a copper core, a phosphor coating, an outer coil winding, and one or more sleeves thereover. The wire 30 comprises an elongated length, a diameter, and a stiffness that allows the wire to be bent or curved into patters to conform to various mask shapes or to create various wire designs along the interior or exterior surfaces of the mask 11. The electroluminescent wire 30 extends along the mask surface from a wire connector or an electrical connection 32 with an elongated power wire 31. The power wire 31, or “elongated wire” for short, provides electrical current from a power source disposed on the body of the person to energize and illuminate the electroluminescent wire 30 along is length. The first end of the electroluminescent wire connects at the electrical connection 32 with the elongated wire 31, and extends along the surface of the mask 11. The second end of the wire terminates along the mask surface and is electrically sealed.

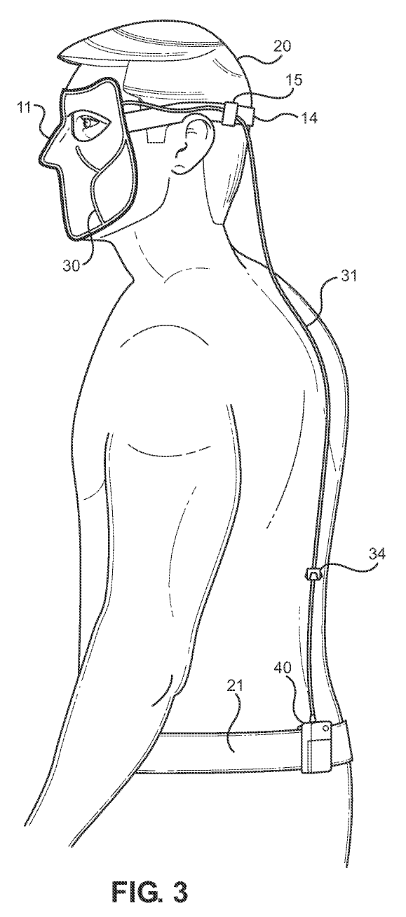

Referring to FIGS. 2 and 3, there are shown side views of the costume mask 11 of the present invention in a working state, being donned on the face 21 of a user and supported on the head 20 of the user via an elongated band 14. The mask supports the electroluminescent device thereon. FIGS. 2 and 3 show the electroluminescent wire 30 embodiment, which is disposed along the exterior surface of the mask 11. The first end of the electroluminescent wire 30 connects to the power wire 31, which is electrically connected to a power source disposed within a housing 40 on the user's body. The power source is coupled to an electric circuit, which controls the current output of the battery power source of the housing 40, and directs current through the power wire 31 and into the electroluminescent device on the mask 11. When current flows through the electroluminescent device, the electroluminescent device illuminates. When current is ceased, the electroluminescent device ceases illuminating. An activation switch may be provided on the housing 40 to control the flow of current to the mask 11.

Along the length of the power wire 31 may be a quick connect coupling 34 to allow the upper portion of the power wire 31 to readily detach from the housing 40 while donning the mask 11. This prevents the mask 11 from being tugged by the housing 40 of the power wire 31, and prevents the electroluminescent wire 31 from being dislodged from the mask 11 as a result. This further prevents entanglements with the user and the power wire 31 along its length. Finally, this allows replacement power sources to be provided without removing the mask 11, whereby a replacement housing 40 may be attached to the mask 11 by decoupling the first housing and replacing it with a substitute.

Moreover, to control the power wire 31 near the mask 11 and along the head 20 of the wearer, a wire support 15 in the form of a clip or sleeve may be provided along the edge of the mask or along the band 14 supporting the mask 11. The wire support 14 prevents the power wire from dangling while the mask 11 is worn, thereby preventing tugging on the mask 11 by a dangling wire. The power wire 31 can furthermore be routed behind the user's head 20 and down the user's neck using the wire support 15. The wire support 15 supports the weight of the suspended power wire 31, as opposed to the mask 11 directly supporting the weight of the power wire 31.

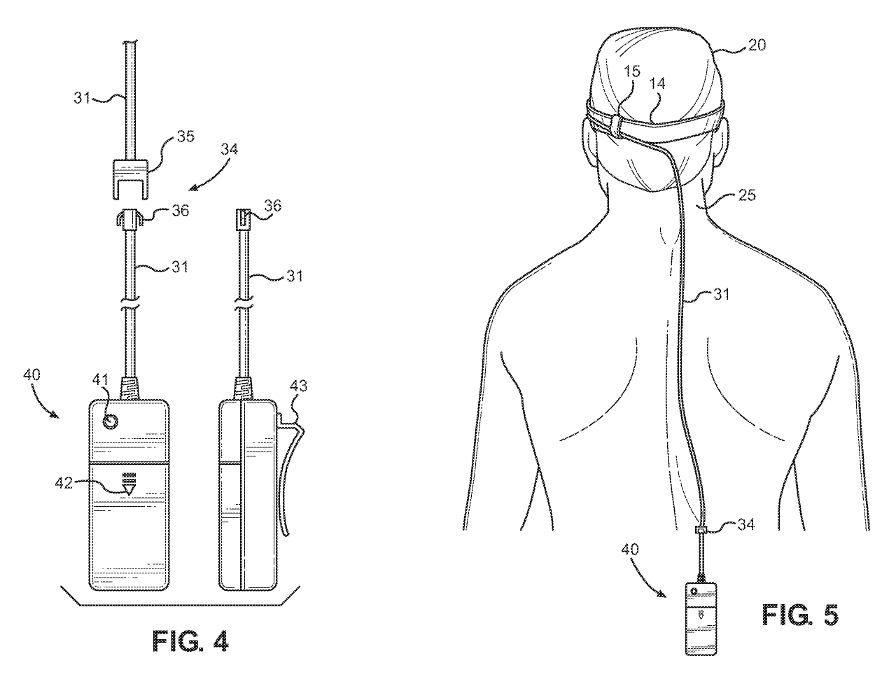

Referring to FIGS. 4 and 5, a close-up of the power source housing 40 and the positioning of the power wire down the neck and along the body of the wearer is shown. Along the length of the power wire 31 is preferably disposed a quick connect coupling 34, which includes a first 35 and second 36 coupling member. The quick connect coupling 34 allows the power wire 31 to ready separate into two separate lengths at a point along its length. This allows the user to break connection with the power source housing 40 rather than displace either the housing 40 or the mask 11 when the wire 31 is stretched to its maximum and tension is developed along the wire 31. The housing 40 may include an activation button 41, which controls an activation switch in the electric circuit therein. Furthermore, the batteries within the housing may be replaceable, whereby access to the batteries is provided by way of a sliding surface 42 therealong. The sliding surface 42 allows access to the interior volume of the housing 40 when access is desired. Finally, the housing may include a belt clip 43 or similar garment attachment for supporting the housing 40 on the user's body and away from the mask location. As an alternative, the housing 40 may be supported closely to the mask and along the user's head. However, it is contemplated that placement along the torso or waist is more desirable. Therefore, an elongated power wire 31 may be provided.

FIG. 5 shows a view of the backside of a user and the elongated power wire 31 suspended from the wire support 15 and disposed along the user's neck 25 and torso. The power wire 31 extends from the electroluminescent device on the mask 11 to the housing 11. Therebetween is the quick coupling 34. The wire support 15 may be disposed along the mask itself, or alternatively along the head band 14 provided to support the mask on the user's face.

The electric circuit within the housing 40 is one that receives as an input the battery power source and outputs a current at a defined amperage that is either alternating or direct current. Most electroluminescent devices require alternating current, therefore a power inverter is necessary to take the direct current from the battery power source and output an alternating current. Also provided within the circuit may be an activation switch, which controls the flow of current from the circuit to the electroluminescent device on the mask. It is not desired to limit the electric circuit to one static configuration, but rather disclose a circuit that one skilled in the art would ready recognize as necessary to control the flow of current from a battery power supply to a electroluminescent wire or electroluminescent panel. The electric circuit is disposed within the housing 40 and controls the flow of current to the electroluminescent device on the mask 11.

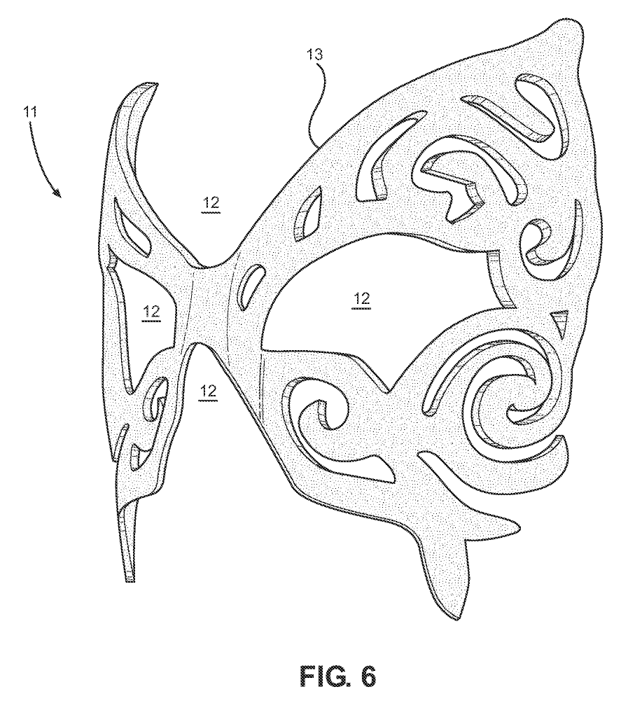

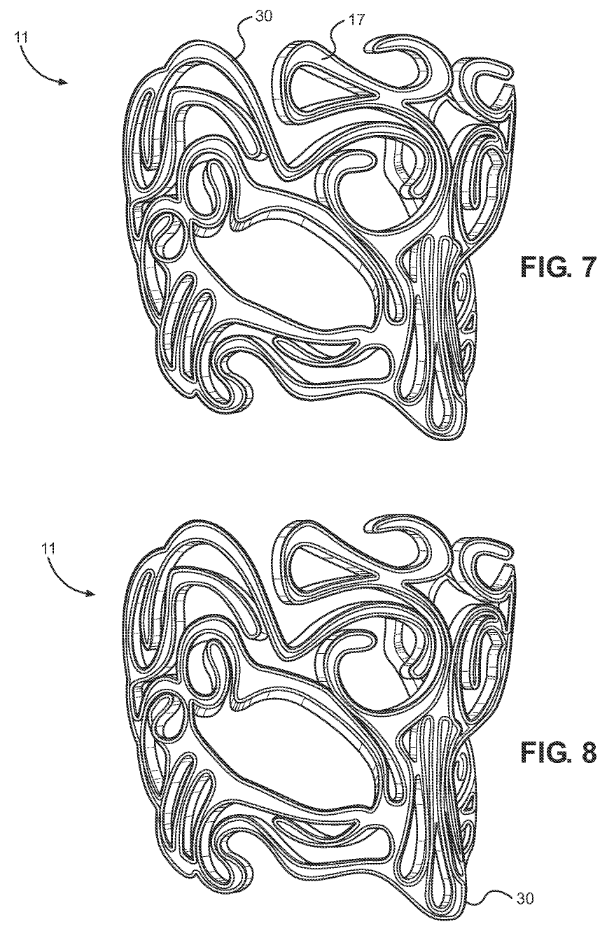

Referring now to FIG. 6, there is shown another embodiment of the costume mask 11 of the present invention. The costume mask 11 includes an exterior surface and an interior surface, and may take on several different designs. The design of the FIG. 6 is one of a face mask, whereby a plurality of apertures 12 is provided for decorative or functional reasons. The apertures provide clearance for the user's eyes, while others are purely ornamental. The outer edge 13 of the mask 11 may also have a specific design, whereby the electroluminescent wire 30 is disposed along either the interior or exterior surface of the mask 11. FIG. 7 presents a view of the mask 11, whereby the mask 11 includes a specific design and the electroluminescent wire 30 is disposed along the exterior surface 17 of the mask. FIG. 8 shows the same mask 11, whereby the electroluminescent wire 30 is energized and illuminated.

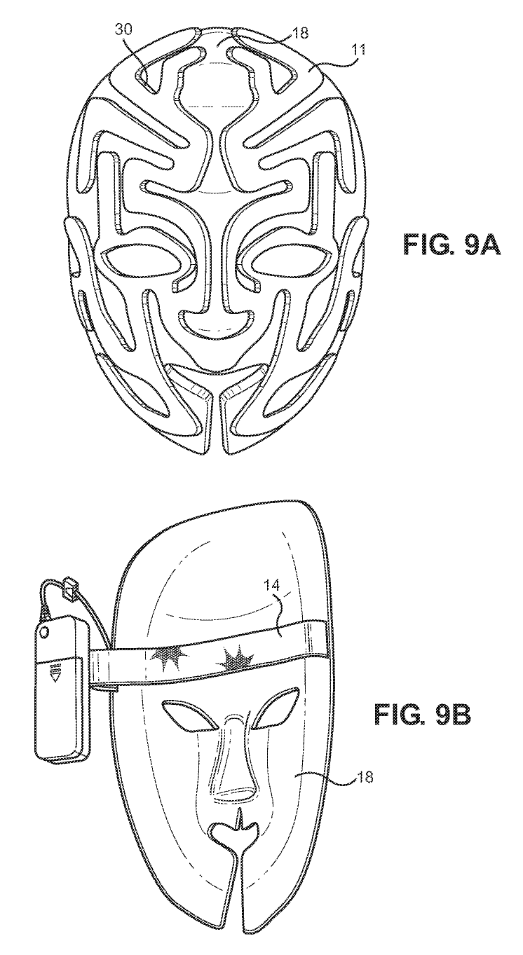

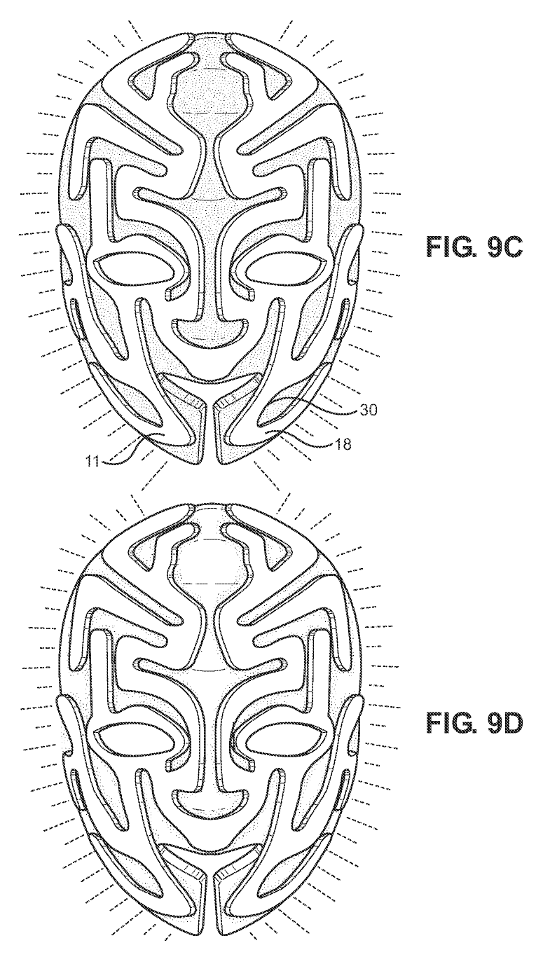

Referring now to FIGS. 9A-D, there are shown several views of the costume mask of the present invention, whereby below the mask is disposed a mask base 18. The mask base 18 is a surface disposed below the costume mask 11 and positioned inboard of the interior surface thereof, whereby the mask base 18 provides a background material over which the shape of the costume mask 11 rests. The mask base 18 provides a background surface that can project light or provide a background that is not the user's actual face or head, providing for more interesting looking mask constructions when the electroluminescent device thereon is illuminated. The electroluminescent device, in the form of electroluminescent wire 30, may be supported along the edges of the costume mask 11, while the mask base 18 may provide a white or black background to reflect or absorb the light thereof when the electroluminescent wire 30 is energized. The head band 14 of the assembly may attach to the mask base or to the mask thereover along the backside of the assembly.

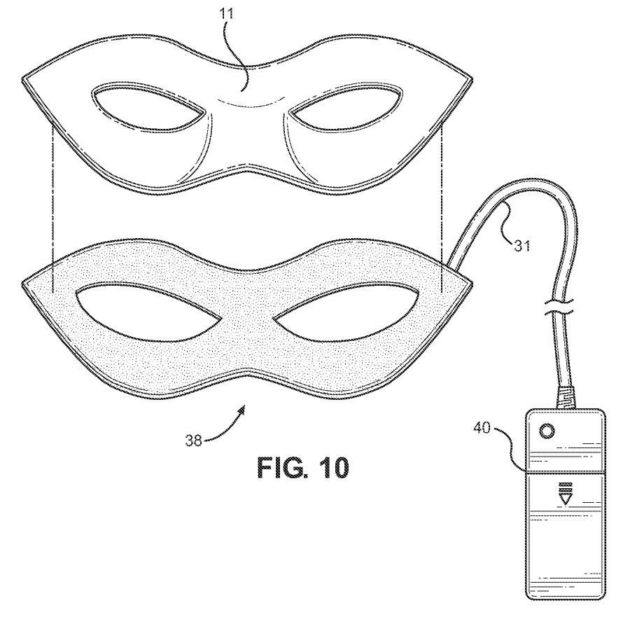

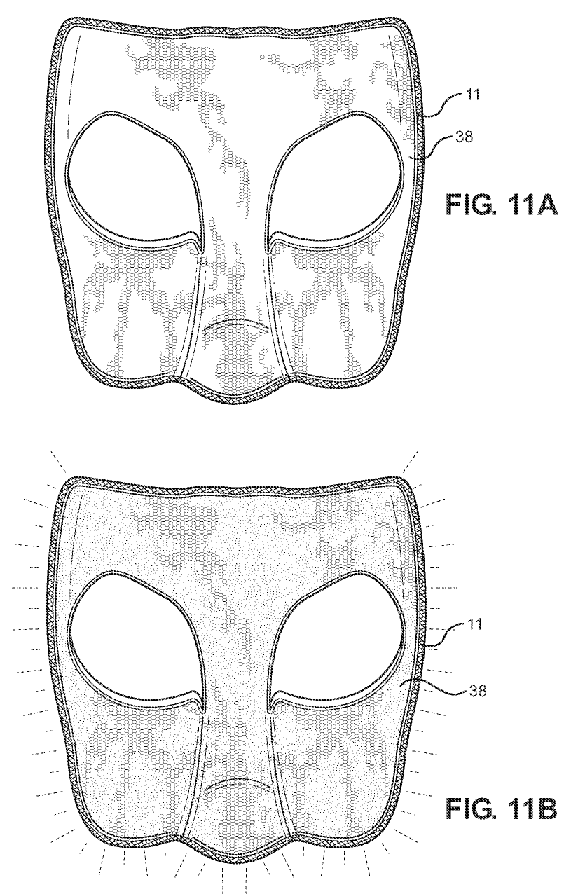

Referring now to FIGS. 10 and 11A-B, there is shown an alternate construction of the mask of the present invention. The costume mask 11 supports one or more electroluminescent panels 38 thereon, whereby the electroluminescent panel 38 projects light from its surface area when a current is supplied by the power wire 31 and the battery power source in the housing 40. The electroluminescent panel 38 comprises a surface area and is one that comprises a capacitor and a dielectric between surface plates within the cross section of the panel 38, whereby the panel gives off light when the capacitor is charged with an electric current. A phosphor within the cross section of the panel gives off photons when the capacitor is charged by the electric current. The panel 38 may be disposed below the mask 11 or over the mask 11 as desired, whereby the panel 38 may provide backlighting or surface lighting along the mask 11. The panel may comprise a surface area or be provided in roll form, whereby the electroluminescent panel 38 is in tape form before being applied to the mask 11.

The mask 11 comprises a material such as hard or flexible plastic, paper, cardboard, cloth material, leather, foam material, or any other suitable mask material. The construction may take on several forms falling within the scope of providing a face or head covering with a specific design, an interior surface, an exterior surface, an outer edge, and optionally one or more apertures. An electroluminescent device such as a electroluminescent wire or electroluminescent panel is used to add illumination to the mask, and the electroluminescent device is disposed along the interior or exterior surfaces of the mask during construction. The electroluminescent device provides a lighted pattern that can be designed into different shapes, patterns, or configurations for the user. The electroluminescent device is electrically coupled to the power wire, either by way of an electrical connector or a soldered connection, whereby current flows from the battery power source through the power wire and into the electroluminescent device for illuminating the same. The mask has a specific design and may further include a mask base supported along the interior of the mask to provide a background for light. Overall, the design incorporates the electroluminescent device for improving the look and ornamental appeal of the costume mask when donned.

It is submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) An illuminating mask device, comprising:
a costume mask having an interior surface and an exterior surface, the costume mask configured to be supported on the head of a user;
an electroluminescent device disposed on the costume mask, the electroluminescent device being configured to illuminate when an electrical current is applied thereto;
a battery power source disposed within a housing;
a circuit electrically connected between the battery power source and the electroluminescent device to control the electrical current applied to the electroluminescent device;
an elongated wire connected to the electroluminescent device and extending from the costume mask;
the elongated wire coupling the electroluminescent device to the electric circuit.

2) The illuminating mask device of claim 1, wherein:
the electroluminescent device comprises an elongated electroluminescent wire that emits light along its length when the electrical current is applied thereto.

3) The illuminating mask device of claim 1, wherein the electroluminescent wire is disposed along the exterior surface of the costume mask.

4) The illuminating mask device of claim 1, wherein the electroluminescent wire is disposed along the interior surface of the costume mask.

5) The illuminating mask device of claim 1, wherein:
the electroluminescent device comprises an electroluminescent panel that emits light along its surface area when the electrical current is applied thereto.

6) The illuminating mask device of claim 1, wherein the electroluminescent panel is disposed along the exterior surface of the costume mask.

7) The illuminating mask device of claim 1, wherein the electroluminescent panel is disposed along the interior surface of the costume mask.

8) The illuminating mask device of claim 1, wherein the housing further comprise a clip to affix the housing to an article of clothing.

9) The illuminating mask device of claim 1, further comprising an activation switch between the battery power source and the electroluminescent device.

10) The illuminating mask device of claim 1, further comprising a quick connect member along the elongated wire that facilitates disconnecting the housing from the costume mask.

11) The illuminating mask device of claim 1, whereby the costume mask comprises one or more apertures therethrough.

12) The illuminating mask device of claim 1, further comprising a band configured to encircle the head of a user and secure the costume mask thereto.

13) The illuminating mask device of claim 1, further comprising a mask base disposed along the interior surface of the costume mask, the mask base comprising an outer surface in connection with the interior surface of the mask base and substantially coextensive therewith.

14) The illuminating mask device of claim 1, further comprising a wire support that supports the elongated wire adjacent to the costume mask.

15) A method of creating an illuminated costume mask, comprising the steps of:
creating a costume mask configured to be supported on the head of a user;
placing an electroluminescent device onto the costume mask that is configured to illuminate when an electrical current is applied thereto;
providing a battery power source and circuit within a body-worn housing that is electrically coupled to the electroluminescent device.

16) The method of claim 15, further comprising:
connecting the electroluminescent device to an exterior surface of the costume mask.

17) The method of claim 15, further comprising:
connecting the electroluminescent device to an interior surface of the costume mask.

18) The method of claim 15, wherein the electroluminescent device comprises an electroluminescent wire that emits light along its length when the electrical current is applied thereto.

19) The method of claim 15, wherein the electroluminescent device comprises an electroluminescent panel that emits light along its surface area when the electrical current is applied thereto.

20) The method of claim 15, further comprising:
coupling the body-worn housing to the electroluminescent device using an elongated wire having a quick member therealong that facilitates disconnecting the housing from the costume mask.
